(19) United States
(12) Patent Application Publication
(10) Pub. No.: US 2015/0309956 A1
(43) Pub. Date: Oct. 29, 2015

(54) DATA TERMINAL, DATA TRANSMISSION SYSTEM, AND HOT SWAPPING CONTROL METHOD

(71) Applicant: Huawei Device Co., Ltd., Shenzhen (CN)

(72) Inventors: Shuqiang GONG, Shenzhen (CN); Menglong ZHAO, Shenzhen (CN)

(21) Appl. No.: 14/793,545

(22) Filed: Jul. 7, 2015

Related U.S. Application Data
(63) Continuation of application No. PCT/CN2013/078716, filed on Jul. 3, 2013.

(30) Foreign Application Priority Data
Jan. 7, 2013 (CN) 201310005183.1

(51) Int. Cl. G06F 13/40

(52) U.S. Cl. CPC G06F 13/4081; G06F 13/4022

(57) ABSTRACT

The present invention discloses a data terminal, a data transmission system, and a hot swapping control method. The data terminal includes a first processor, a first digital audio circuit, an interface isolator, a first USB circuit, and a first connecting apparatus, where the first connecting apparatus includes a first digital audio connecting apparatus and a first USB connecting apparatus. An initial status of the interface isolator is controlled by using a hot swapping feature of the first USB circuit, so that voice data transmission is performed between the first processor and a computer by using the first digital audio circuit and the first digital audio connecting apparatus, and the first digital audio circuit has the hot swapping feature when the first digital audio circuit is applied to the data terminal.

### CROSS-REFERENCE

This application is a continuation of International Application PCT/CN2013/078716, filed on Jul. 3, 2013, which claims priority to Chinese Patent Application No. 201310005183.1, filed on Jan. 7, 2013, both of which are hereby incorporated by reference in their entireties.

### TECHNICAL FIELD

The present invention relates to the field of communications technologies, and in particular, to a data terminal, a data transmission system, and a hot swapping control method.

### BACKGROUND

Currently, most data terminals for implementing a data service work as a lower computer, and use a universal serial bus (USB) interface or a Peripheral Component Interconnect Express (PCIE) interface to communicate with a host computer. An important feature of a data terminal is supporting a hot swapping (Hot swapping) function, namely “live swapping”, indicating that the data terminal can be inserted or removed during operation of a computer, which does not cause circuit burnout of the computer or the data terminal and enables the computer to detect and use the data terminal in a timely manner.

With the development of technologies, some data terminals implement a voice function, and a voice data exchange is implemented between the data terminals and a computer by using a USB interface or a PCIE interface. The USB interface is used as an example, and a process of the voice data exchange includes that: after a data terminal is connected to a USB interface of the computer in a matching manner by using the USB interface, the computer sends a command to the data terminal by using the USB interface, and establishes a voice communication connection between the computer and the data terminal; after using a voice device to collect a voice signal, the computer processes the voice signal to obtain processed voice data, and sends the voice data to the data terminal by using the USB interface, implementing voice data transmission between the computer and the data terminal.

When the voice data transmission is performed between the data terminal and the computer by using the USB interface or a PCIE interface, because the USB interface and the PCIE interface basically transmit data in a bulk manner, and voice data cannot be transmitted preferably when the data is transmitted in the bulk manner, voice data and service data except for voice data are transmitted in a first-in first-out manner, so that the voice data is congested by a large amount of service data, and it is difficult to effectively implement real-time voice data transmission.

To ensure the real-time voice data transmission of the data terminal, a digital audio interface may be used in the data terminal to transmit the voice data. However, the digital audio interface does not have a hot swapping function and is inapplicable to a hot swapping occasion, causing that the data terminal fails to have the hot swapping function when the digital audio interface is applied to the data terminal. Therefore, usage of the digital audio interface in the data terminal is limited.

### SUMMARY

A data terminal is provided, and is configured to implement voice data exchange with a computer by using a first digital audio circuit and a first digital audio connecting apparatus after the data terminal is connected to the computer.

A first aspect of the present invention provides a data terminal, including:

a first processor, a first digital audio circuit, an interface isolator, a first universal serial bus USB circuit, and a first connecting apparatus, where the first connecting apparatus includes a first digital audio connecting apparatus and a first USB connecting apparatus, and the first USB circuit has a hot swapping feature;

the first processor is connected to the first digital audio circuit, the first processor is further connected to the first USB circuit, the first digital audio circuit is connected to the interface isolator, the interface isolator is connected to the first digital audio connecting apparatus, and the first USB circuit is connected to the first USB connecting apparatus;

after the data terminal is connected to a computer by using the first connecting apparatus, an initial status of the interface isolator is a disconnected state and the first USB circuit enters an initialization process; the first processor is configured to: after initialization of the first USB circuit is complete, negotiate with the computer by using the first USB circuit and the first USB connecting apparatus, determine a first configuration parameter of the first digital audio circuit, and configure the first digital audio circuit according to the first configuration parameter; and

after configuration on the first digital audio circuit is complete, the interface isolator receives a connection command, and switches from the disconnected state to a connected state according to the connection command, so that a channel between the first digital audio circuit and the first digital audio connecting apparatus is connected, and voice data transmission is performed between the first processor and the computer by using the first digital audio circuit and the first digital audio connecting apparatus.

In a first possible implementation manner, the first digital audio connecting apparatus and the first USB connecting apparatus are integrated in the first connecting apparatus.

With reference to the first aspect or the first possible implementation manner of the first aspect, in a second possible implementation manner, that the interface isolator receives a connection command is specifically that: the interface isolator receives the connection command from the first digital audio circuit; or the interface isolator receives the connection command from the first processor.

With reference to the first aspect, the first possible implementation manner of the first aspect, or the second possible implementation manner of the first aspect, in a third possible implementation manner, the first digital audio circuit is a pulse code modulation PCM circuit or an integrate interface of sound IIS circuit.

With reference to the first aspect, the first possible implementation manner of the first aspect, the second possible implementation manner of the first aspect, or the third possible implementation manner of the first aspect, in a fourth possible implementation manner, the data terminal further includes a power management circuit, and the power management circuit is connected to the first processor, the first digital audio circuit, the first USB circuit, and the interface isolator; the power management circuit is configured to provide electric energy for the first processor, the first digital audio circuit, the first USB circuit, and the interface isolator; and the power management circuit is further connected to the first USB connecting apparatus of the first connecting apparatus, so that the power management circuit acquires electric energy from the computer after the first connecting apparatus is connected to the computer.

With reference to the first aspect, the first possible implementation manner of the first aspect, the second possible implementation manner of the first aspect, the third possible implementation manner of the first aspect, or the fourth possible implementation manner of the first aspect, in a fifth possible implementation manner, the data terminal further includes a radio frequency circuit that is configured to send a radio frequency signal to a wireless network or receive a radio frequency signal from a wireless network, the radio frequency circuit is connected to the first processor, and the radio frequency circuit is further connected to the power management circuit.

With reference to the first aspect, the first possible implementation manner of the first aspect, the second possible implementation manner of the first aspect, the third possible implementation manner of the first aspect, the fourth possible implementation manner of the first aspect, or the fifth possible implementation manner of the first aspect, in a sixth possible implementation manner, the first processor is further configured to: after the interface isolator switches from the disconnected state to the connected state, receive, by using the first digital audio connecting apparatus and the first digital audio circuit, voice data transmitted by the computer, process the voice data to obtain a baseband signal, and send the baseband signal to the radio frequency circuit, and the radio frequency circuit is configured to modulate the baseband signal into a radio frequency signal, and send the radio frequency signal to the wireless network; the first processor is further configured to: receive, by using the first USB connecting apparatus and the first USB circuit, service data sent by the computer, process the service data to obtain a baseband signal, and send the baseband signal to the radio frequency circuit, and the radio frequency circuit is further configured to modulate the baseband signal into a radio frequency signal, and send the radio frequency signal to the wireless network;

the radio frequency circuit is further configured to: receive a radio frequency signal sent by the wireless network, modulate the radio frequency signal into a baseband signal, and send the baseband signal to the first processor; and the first processor is further configured to: process the baseband signal to obtain voice data or service data, send the voice data to the computer by using the first digital audio circuit and the first digital audio connecting apparatus, or send the service data to the computer by using the first USB circuit and the first USB connecting apparatus; and

the first processor is further configured to receive, by using the first USB connecting apparatus and the first USB circuit, a system control command sent by the computer, or is configured to send a system control command to the computer by using the first USB connecting apparatus and the first USB circuit.

A second aspect of the present invention provides a data transmission system, including: a data terminal and a computer, where

the data terminal includes a first processor, a first digital audio circuit, an interface isolator, a first universal serial bus USB circuit, and a first connecting apparatus, where the first connecting apparatus includes a first digital audio connecting apparatus and a first USB connecting apparatus, and the first USB circuit has a hot swapping feature;

the first processor is connected to the first digital audio circuit, the first processor is further connected to the first USB circuit, the first digital audio circuit is connected to the interface isolator, the interface isolator is connected to the first digital audio connecting apparatus, and the first USB circuit is connected to the first USB connecting apparatus;

the computer includes a second processor, a second digital audio circuit, a second USB circuit, a second connecting apparatus, where the second connecting apparatus includes a second digital audio connecting apparatus and a second USB connecting apparatus, and the second USB circuit has a hot swapping feature;

the second processor is connected to the second digital audio circuit, the second processor is further connected to the second USB circuit, the second digital audio circuit is connected to the second digital audio connecting apparatus, and the second USB circuit is connected to the second USB connecting apparatus;

the first connecting apparatus is configured to connect to the second connecting apparatus, so that the data terminal is connected to the computer, where the first digital audio connecting apparatus is configured to connect to the second digital audio connecting apparatus, and the first USB connecting apparatus is configured to connect to the second USB connecting apparatus;

after the data terminal is connected to the second connecting apparatus of the computer by using the first connecting apparatus, an initial status of the interface isolator is a disconnected state, and the first USB circuit and the second USB circuit enter an initialization process; after initialization of the first USB circuit and the second USB circuit is complete, the first processor negotiates with the second processor by using the first USB circuit, the first USB connecting apparatus, the second USB connecting apparatus, and the second USB circuit, and determines a first configuration parameter of the first digital audio circuit and a second configuration parameter of the second digital audio circuit; the first processor configures the first digital audio circuit according to the first configuration parameter, and the second processor configures the second digital audio circuit according to the second configuration parameter; and

after configuration on the first digital audio circuit and the second digital audio circuit is complete, the interface isolator receives a connection command, and switches from the disconnected state to a connected state according to the connection command, so that a channel among the first digital audio circuit, the first digital audio connecting apparatus, the second digital audio connecting apparatus, and the second digital audio circuit is connected, and voice data transmission is performed between the first processor and the second processor by using the first digital audio circuit, the first digital audio connecting apparatus, the second digital audio connecting apparatus, and the second digital audio circuit.

In a first possible implementation manner of the second aspect, the first connecting apparatus is connected to the second connecting apparatus in a swappable manner; and the interface isolator switches from the connected state to the disconnected state after a connection between the first connecting apparatus and the second connecting apparatus is disconnected.

With reference to the second aspect or the first possible implementation manner of the second aspect, in a second possible implementation manner, the first digital audio connecting apparatus and the first USB connecting apparatus are integrated in the first connecting apparatus; and the second digital audio connecting apparatus and the second USB connecting apparatus are integrated in the second connecting apparatus.

With reference to the second aspect, the first possible implementation manner of the second aspect, or the second possible implementation manner of the second aspect, in a third possible implementation manner of the second aspect, that the interface isolator receives a connection command is specifically that: the interface isolator receives the connection command from the first digital audio circuit; or the interface isolator receives the connection command from the first processor.

With reference to the second aspect, the first possible implementation manner of the second aspect, the second possible implementation manner of the second aspect, or the third possible implementation manner of the second aspect, in a fourth possible implementation manner of the second aspect, the first digital audio circuit is a pulse code modulation PCM circuit or an integrate interface of sound IIS circuit, and the second digital audio circuit is a PCM circuit or an IIS circuit.

With reference to the second aspect, the first possible implementation manner of the second aspect, the second possible implementation manner of the second aspect, the third possible implementation manner of the second aspect, or the fourth possible implementation manner of the second aspect, in a fifth possible implementation manner of the second aspect, the data terminal further includes a power management circuit, and the computer further includes a power circuit;

the power management circuit is connected to the first processor, the first digital audio circuit, the interface isolator, and the first USB circuit; and

the power management circuit is further connected to the first USB connecting apparatus, and the power circuit is connected to the second USB connecting apparatus, so that after the first USB connecting apparatus and the second connecting apparatus are connected, the power management circuit is configured to acquire electric energy from the power circuit and provide electric energy for the first processor, the first digital audio circuit, the interface isolator, and the first USB circuit.

With reference to the second aspect, the first possible implementation manner of the second aspect, the second possible implementation manner of the second aspect, the third possible implementation manner of the second aspect, the fourth possible implementation manner of the second aspect, or the fifth possible implementation manner of the second aspect, in a sixth possible implementation manner, the data terminal further includes a radio frequency circuit that is configured to send a radio frequency signal to a wireless network or receive a radio frequency signal from a wireless network, the radio frequency circuit is connected to the first processor, and the radio frequency circuit is connected to the power management circuit.

With reference to the second aspect, the first possible implementation manner of the second aspect, the second possible implementation manner of the second aspect, the third possible implementation manner of the second aspect, the fourth possible implementation manner of the second aspect, the fifth possible implementation manner of the second aspect, or the sixth possible implementation manner of the second aspect, in a seventh possible implementation manner, the first processor is further configured to: after the interface isolator switches from the disconnected state to the connected state, receive voice data that is transmitted by the second processor by using the second digital audio circuit, the second digital audio connecting apparatus, the first digital audio connecting apparatus, and the first digital audio circuit, process the voice data to obtain a baseband signal, and send the baseband signal to the radio frequency circuit, and the radio frequency circuit is configured to modulate the baseband signal into a radio frequency signal, and send the radio frequency signal to the wireless network; and the first processor is further configured to: receive service data that is sent by the second processor by using the second USB connecting apparatus, the second USB circuit, the first USB connecting apparatus, and the first USB circuit, process the service data to obtain a baseband signal, and send the baseband signal to the radio frequency circuit, and the radio frequency circuit is further configured to modulate the baseband signal into a radio frequency signal, and send the radio frequency signal to the wireless network;

the radio frequency circuit is further configured to: receive a radio frequency signal sent by the wireless network, modulate the radio frequency signal into a baseband signal, and send the baseband signal to the first processor; and the first processor is further configured to: process the baseband signal to obtain voice data or service data, send the voice data to the second processor by using the first digital audio circuit, the first digital audio connecting apparatus, the second digital audio connecting apparatus, and the second digital audio circuit, or send the service data to the second processor by using the first USB circuit, the first USB connecting apparatus, the second USB connecting apparatus, and the second USB circuit; and

the first processor is further configured to receive a system control command that is sent by the second processor by using the second USB connecting apparatus, the second USB circuit, the first USB connecting apparatus, and the first USB circuit, or is configured to send a system control command to the second processor by using the first USB circuit, the first USB connecting apparatus, the second USB connecting apparatus, and the second USB circuit.

A third aspect of the present invention provides a hot swapping control method, where the hot swapping control method is applied to a data terminal, and the data terminal includes a first interface, where the first interface includes a first digital audio interface and a first USB interface, and the first USB interface has a hot swapping feature; and

the hot swapping control method includes:

after the data terminal is connected to a computer by using the first interface, initializing the first USB interface, where an initial status of a channel between the first digital audio interface and the computer is a disconnected state;

after initialization of the first USB interface is complete, negotiating, by the data terminal, with the computer by using the first USB interface, and determining a first configuration parameter of the first digital audio interface;

configuring, by the data terminal, the first digital audio interface according to the first configuration parameter; and

connecting the channel between the first digital audio interface and the computer, so that voice data transmission is performed between the data terminal and the computer by using the first digital audio interface.

In a first possible implementation manner of the third aspect, after the connecting the channel between the first digital audio interface and the computer, the method further includes:

receiving, by the data terminal by using the first digital audio interface, voice data transmitted by the computer, or receiving, by using the first USB interface, service data transmitted by the computer; and

processing, by the data terminal, the voice data or the service data to obtain a radio frequency signal, and sending the radio frequency signal to a wireless network.

With reference to the third aspect or the first possible implementation manner of the third aspect, in a second possible implementation manner, after the connecting the channel between the first digital audio interface and the computer, the method further includes:

receiving, by the data terminal, a radio frequency signal sent by the wireless network;

processing, by the data terminal, the radio frequency signal to obtain voice data or service data; and

transmitting, by the data terminal, the voice data to the computer by using the first digital audio interface, or transmitting the service data to the computer by using the first USB interface.

With reference to the third aspect, the first possible implementation manner of the third aspect, or the second possible implementation manner of the third aspect, in a third possible implementation manner of the third aspect, the hot swapping control method further includes:

receiving or sending, by the data terminal, a system control command by using the first USB interface.

It can be seen from the foregoing technical solutions that, the embodiments of the present invention have the following advantages:

By using a hot swapping feature of a first USB circuit, negotiation on a configuration parameter of a first digital audio circuit is complete, and after parameter configuration on the first digital audio circuit is complete, a channel between the first digital audio circuit and a first digital audio connecting apparatus is connected, so that voice data transmission may be performed between a first processor and a computer by using the first digital audio circuit and the first digital audio connecting apparatus, and the first digital audio circuit has the hot swapping feature when the first digital audio circuit is applied to a data terminal.

### BRIEF DESCRIPTION OF DRAWINGS

FIG. 1 is a schematic diagram of a structure of a data terminal according to an embodiment of the present invention;

FIG. 2 is another schematic diagram of a structure of a data terminal according to an embodiment of the present invention;

FIG. 3 is a schematic diagram of a structure of a data transmission system according to an embodiment of the present invention;

FIG. 4 is another schematic diagram of a structure of a data transmission system according to an embodiment of the present invention;

FIG. 5 is a schematic diagram of a first connecting apparatus according to an embodiment of the present invention; and

FIG. 6 is a schematic diagram of a hot swapping control method according to an embodiment of the present invention.

### DESCRIPTION OF EMBODIMENTS

Embodiments of the present invention provide a data terminal, a data transmission system, and a hot swapping control method, which implements a hot swapping feature of a first digital audio circuit in the data terminal, so that the first digital audio circuit can be used in the data terminal to implement voice data transmission.

First, it should be noted that, a data terminal mentioned in the embodiments of the present invention may be a wireless WAN card, a wireless modem, or the like that has a voice function; a computer mentioned in the embodiments of the present invention may be a terminal device that can implement a computer function, such as a PC, a tablet, or a smartphone.

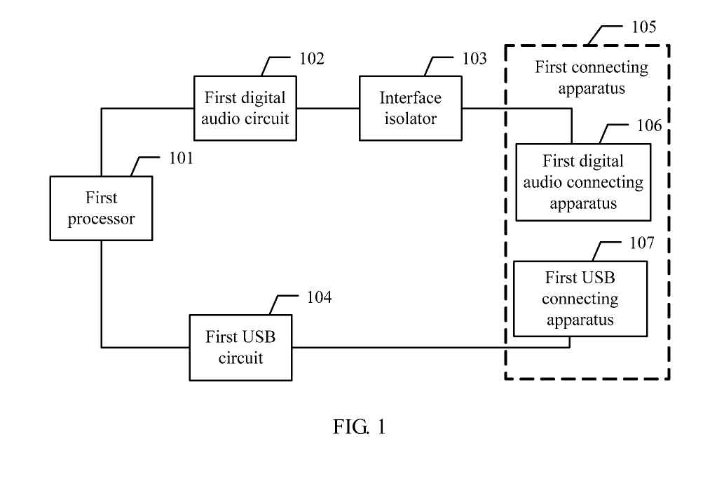

Referring to FIG. 1, FIG. 1 is a schematic diagram of a structure of a data terminal according to an embodiment of the present invention, where the data terminal includes:

a first processor 101, a first digital audio circuit 102, an interface isolator 103, a first USB circuit 104, and a first connecting apparatus 105, where the first connecting apparatus 105 includes a first digital audio connecting apparatus 106 and a first USB connecting apparatus 107, and the first USB circuit 104 has a hot swapping feature.

The first processor 101 is connected to the first digital audio circuit 102, the first processor 101 is further connected to the first USB circuit 104, the first digital audio circuit 102 is connected to the interface isolator 103, the first digital audio connecting apparatus 106 is connected to the interface isolator 103, and the first USB connecting apparatus 107 is connected to the first USB circuit 104.

After the data terminal is connected to a computer by using the first connecting apparatus 105, an initial status of the interface isolator 103 is a disconnected state and the first USB circuit 104 enters an initialization process; the first processor 101 is configured to: after initialization of the first USB circuit 104 is complete, negotiate with the computer by using the first USB circuit 104 and the first USB connecting apparatus 107, determine a first configuration parameter of the first digital audio circuit 102, and configure the first digital audio circuit 102 according to the first configuration parameter.

After configuration on the first digital audio circuit 102 is complete, the interface isolator 103 receives a connection command, and switches from the disconnected state to a connected state according to the connection command, so that a channel between the first digital audio circuit 102 and the first digital audio connecting apparatus 106 is connected, and voice data transmission may be performed between the first processor 101 and the computer by using the first digital audio circuit 102 and the first digital audio connecting apparatus 106.

Optionally, in this embodiment of the present invention, the first digital audio connecting apparatus 106 and the first USB connecting apparatus 107 are integrated in the first connecting apparatus 105.

Optionally, in this embodiment of the present invention, that the interface isolator 103 receives a connection command is specifically that: the interface isolator 103 receives the connection command from the first digital audio circuit 102; or the interface isolator 103 receives the connection command from the first processor 101.

In this embodiment of the present invention, after the first connecting apparatus 105 is connected to the computer, the initial status of the interface isolator 103 is the disconnected state, the first digital audio circuit 102 is electrically disconnected from the computer, and the first USB circuit 104 is to start an exchange process, implementing initialization of the first USB circuit 104; after the first USB circuit 104 completes the initialization, the first processor 101 of the data terminal negotiates with the computer by using the first USB circuit 104 and the first USB connecting apparatus 107, and determines a first configuration parameter of the first digital audio circuit 102, where the configuration parameter includes a communication frequency, a frame format, a working mode, and the like, and the first processor 101 configures the first digital audio circuit 102 according to the first configuration parameter. It should be noted that, when the first processor 101 negotiates with the computer by using the first USB circuit 104 and the first USB connecting apparatus 107, and determines the first configuration parameter of the first digital audio circuit 102, the computer also determines a second configuration parameter of a second digital audio circuit of the computer and configures the second digital audio circuit of the computer according to the second configuration parameter; after the first processor 101 completes parameter configuration on the first digital audio circuit 102 and the computer completes parameter configuration on the second digital audio circuit on the computer, the interface isolator 103 receives the connection command, and the interface isolator 103 switches from the disconnected state to the connected state according to the connection command, so that the channel between the first digital audio circuit 102 and the first digital audio connecting apparatus 106 is connected, and the first digital audio circuit 102 has a hot swapping feature.

In this embodiment of the present invention, after the first connecting apparatus 105 is connected to the computer, service data or a system control command sent by the computer is transmitted to the first processor 101 by using the first USB connecting apparatus 107 and the first USB circuit 104, so that the first processor 101 may obtain the service data or the system control command sent by the computer; or the first processor 101 may send service data or a system control command to the computer by using the first USB circuit 104 and the first USB connecting apparatus 107, so that the computer may receive the service data or the system control command sent by the data terminal.

In this embodiment of the present invention, after the interface isolator 103 switches from the disconnected state to the connected state, voice data transmission may be further implemented between the computer and the data terminal. Specifically, voice data sent by the computer is transmitted to the first processor 101 by using the first digital audio connecting apparatus 106 and the first digital audio circuit 102, so that the first processor 101 may obtain the voice data sent by the computer; or the first processor 101 of the data terminal may send voice data to the computer by using the first digital audio circuit 102 and the first digital audio connecting apparatus 106, so that the computer may receive the voice data sent by the data terminal.

It should be noted that, in this embodiment of the present invention, the service data does not include the voice data.

In this embodiment of the present invention, the first digital audio circuit 102 may be a pulse code modulation (PCM) circuit or may be an integrate interface of sound (IIS) circuit. The voice data is transmitted by using the first digital audio circuit 102 in the data terminal, which can effectively ensure real-time voice data transmission.

In this embodiment of the present invention, the first connecting apparatus 105 is a physical module that is divided in terms of a physical entity structure and is configured to connect to the computer, for example, the first connecting apparatus 105 may be a connecting groove, a connector, or a general socket, where a circuit pin may be included.

In this embodiment of the present invention, when the first connecting apparatus 105 is connected to an interface in the computer in a matching manner, and the interface isolator 103 is in the connected state, an exchange on the voice data, the service data, and the system control command may be performed between the data terminal and the computer; if a connection between the data terminal and the computer is disconnected or the computer is powered off, the interface isolator 103 switches from the connected state to the disconnected state.

In this embodiment of the present invention, the disconnected state of the interface isolator 103 refers to that a pin of the interface isolator 103 is in a high-impedance state; or when a pin on a side on which the interface isolator 103 is connected to the computer is in an input state, and the pin does not affect a change of a level of a connected signal cable, a state in which the interface isolator 103 is also the disconnected state. The connected state of the interface isolator 103 refers to another state, except for the disconnected state, in which data transmission can be performed normally.

It should be noted that, in this embodiment of the present invention, there may be a plurality of implementation manners of disconnecting and connecting a channel between the first digital audio circuit 102 and the first digital audio connecting apparatus 106, using the interface isolator 103 is only one feasible implementation manner of the plurality of implementation manners, and another hardware manner such as a switch may be used for implementation, or a software manner may also be used for implementation, provided that connection and disconnection of the channel between the first digital audio circuit 102 and the first digital audio connecting apparatus 106 can be implemented. Therefore, in an actual application, an implementation manner of the connection and the disconnection of the channel may be set according to a specific situation.

In this embodiment of the present invention, a data terminal includes a first digital audio circuit 102 configured to transmit voice data and an interface isolator 103 configured to implement hot swapping control over the first digital audio circuit 102, so that after a first connecting apparatus 105 of the data terminal is connected to an interface of a computer in a matching manner, a first processor 101 of the data terminal may negotiate with the computer by using a first USB circuit 104 and a first USB connecting apparatus and determine a first configuration parameter of the first digital audio circuit 102, and the first processor 101 completes configuration on the first digital audio circuit 102 according to the first configuration parameter; after the configuration on the first digital audio circuit 102 is complete, the interface isolator 103 receives a connection command, and the interface isolator 103 switches from a disconnected state to a connected state according to the connection command, so that a channel between the first digital audio circuit 102 and a first digital audio connecting apparatus 106 is connected, implementing the hot swapping control over the first digital audio circuit 102. Therefore, the first digital audio circuit 102 may be used in the data terminal to implement voice data transmission.

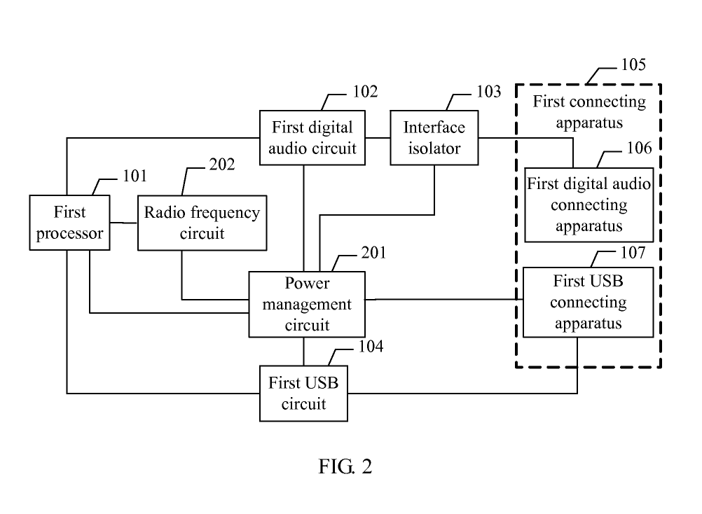

Referring to FIG. 2, FIG. 2 is a schematic diagram of a structure of a data terminal according to an embodiment of the present invention, where the data terminal includes: the first processor 101, the first digital audio circuit 102, the interface isolator 103, the first USB circuit 104, and the first connecting apparatus 105 that are described in the embodiment shown in FIG. 1. Content of the first processor 101, the first digital audio circuit 102, the interface isolator 103, the first USB circuit 104, and the first connecting apparatus 105 is similar to the content described in the embodiment shown in FIG. 1, and details are not described herein again.

In this embodiment of the present invention, the data terminal further includes a power management circuit 201, where the power management circuit 201 is connected to the first processor 101, the first digital audio circuit 102, the interface isolator 103, and the first USB circuit 104. The power management circuit 201 is configured to provide electric energy for the first processor 101, the first digital audio circuit 102, the interface isolator 103, and the first USB circuit 104. In addition, the power management circuit 201 is further connected to the first USB connecting apparatus 107 of the first connecting apparatus 105, so that after the first connecting apparatus 105 is connected to the computer, the power management circuit 201 may acquire electric energy from the computer and provide electric energy for the data terminal.

In this embodiment of the present invention, the power management circuit 201 may be a power management integrated circuit (Power Management Integrated Circuit, PMIC for short).

In this embodiment of the present invention, the data terminal may further include a radio frequency circuit 202 that is configured to send a radio frequency signal to a wireless network or receive a radio frequency signal from a wireless network, the radio frequency circuit 202 is connected to the first processor 101, and the radio frequency circuit 202 is further connected to the power management circuit 201. The first processor 101 may send the radio frequency signal to an external device by using the radio frequency circuit 202, or the radio frequency circuit 202 may modulate the received radio frequency signal into a baseband signal and transmit the baseband signal to the first processor 101.

In this embodiment of the present invention, the first processor 101 is further configured to: after the interface isolator 103 switches from the disconnected state to the connected state, receive, by using the first digital audio connecting apparatus 106, the interface isolator 103, and the first digital audio circuit 102, voice data transmitted by the computer, process the voice data to obtain a baseband signal, and send the baseband signal to the radio frequency circuit 202; and the radio frequency circuit 202 is further configured to modulate the baseband signal into a radio frequency signal, and send the radio frequency signal to the wireless network.

In this embodiment of the present invention, the first processor 101 is further configured to: receive, by using the first USB connecting apparatus 107 and the first USB circuit 104, service data sent by the computer, process the service data to obtain a baseband signal, and send the baseband signal to the radio frequency circuit 202; the radio frequency circuit 202 is further configured to modulate the baseband signal into a radio frequency signal, and send the radio frequency signal to the wireless network.

In this embodiment of the present invention, the radio frequency circuit 202 is further configured to: receive a radio frequency signal sent by the wireless network, modulate the radio frequency signal into a baseband signal, and send the baseband signal to the first processor; and the first processor 101 is further configured to: process the baseband signal to obtain voice data or service data, send the voice data to the computer by using the first digital audio circuit 102 and the first digital audio connecting apparatus 106, or send the service data to the computer by using the first USB circuit 104 and the first USB connecting apparatus 107.

In this embodiment of the present invention, the first processor 101 is further configured to receive, by using the first USB connecting apparatus 107 and the first USB circuit 104, a system control command sent by the computer, or is configured to send a system control command to the computer by using the first USB connecting apparatus 107 and the first USB circuit 104.

In this embodiment of the present invention, a first digital audio circuit 102 configured to transmit voice data and an interface isolator 103 configured to implement hot swapping control over the first digital audio circuit 102 are disposed in a data terminal, so that after a first connecting apparatus 105 of the data terminal is connected to a computer, a first processor 101 of the data terminal may negotiate with the computer by using a first USB circuit 104 and a first USB connecting apparatus 107 and determine a first configuration parameter of the first digital audio circuit 102, and the first processor 101 completes configuration on the first digital audio circuit 101 according to the first configuration parameter; after the configuration on the first digital audio circuit 102 is complete, the interface isolator 103 receives a connection command, and the interface isolator 103 switches from a disconnected state to a connected state according to the connection command, so that a channel between the first digital audio circuit 102 and a first digital audio connecting apparatus 106 is connected, the first digital audio circuit 102 has a hot swapping feature, and the first digital audio circuit 102 can be used in the data terminal to transmit voice data.

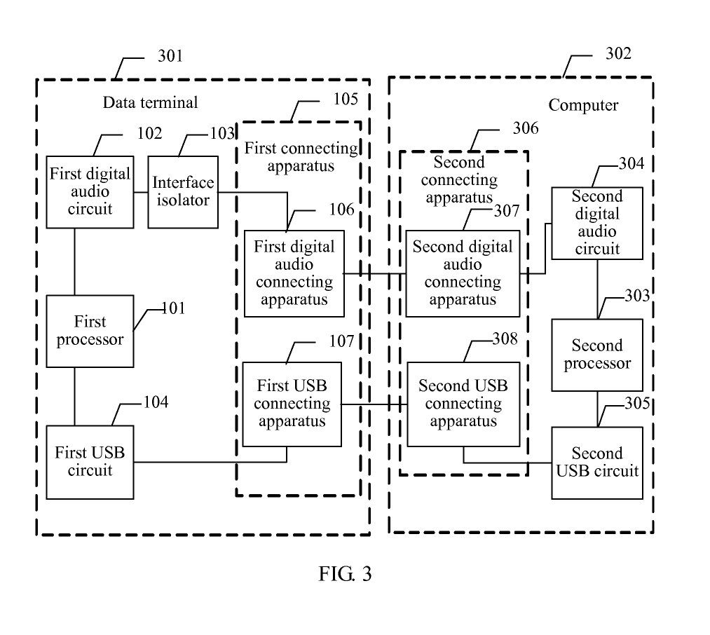

Referring to FIG. 3, FIG. 3 is a schematic diagram of a structure of a data transmission system according to an embodiment of the present invention, where the data transmission system includes: a data terminal 301 and a computer 302.

The data terminal 301 includes a first processor 101, a first digital audio circuit 102, an interface isolator 103, a first USB circuit 104, and a first connecting apparatus 105, where the first connecting apparatus 105 includes a first digital audio connecting apparatus 106 and a first USB connecting apparatus 107, and the first USB circuit 104 has a hot swapping feature.

The first processor 101 is connected to the first digital audio circuit 102, the first processor 101 is further connected to the first USB circuit 104, the first digital audio circuit 102 is connected to the interface isolator 103, the first digital audio connecting apparatus 106 is connected to the interface isolator 103, and the first USB connecting apparatus 107 is connected to the first USB circuit 104.

The computer 302 includes a second processor 303, a second digital audio circuit 304, a second USB circuit 305, and a second connecting apparatus 306, where the second connecting apparatus 306 includes a second digital audio connecting apparatus 307 and a second USB connecting apparatus 308, and the second USB circuit 305 has a hot swapping feature.

The second processor 303 is connected to the second digital audio circuit 304, the second processor 303 is further connected to the second USB circuit 305, the second digital audio connecting apparatus 307 is connected to the second digital audio circuit 304, and the second USB connecting apparatus 308 is connected to the second USB circuit 305.

The first connecting apparatus 105 is configured to connect to the second connecting apparatus 306, so that the data terminal 301 is connected to the computer 302, the first digital audio connecting apparatus 106 is configured to connect to the second digital audio connecting apparatus 307, and the first USB connecting apparatus 107 is configured to connect to the second USB connecting apparatus 308.

In this embodiment of the present invention, after the data terminal 301 is connected to the second connecting apparatus 306 of the computer 32 by using the first connecting apparatus 105, an initial status of the interface isolator 103 is a disconnected state and the first USB circuit 104 and the second USB circuit 305 enter an initialization process; the first processor 101 is configured to: after initialization of the first USB circuit 104 and the second USB circuit 305 is complete, negotiate with the second processor 303 by using the first USB circuit 104, the first USB connecting apparatus 107, the second USB connecting apparatus 308, and the second USB circuit 305, and determine a first configuration parameter of the first digital audio circuit 102 and a second configuration parameter of the second digital audio circuit 304, where the first configuration parameter and the second configuration parameter include a communication frequency, a frame format, a working mode, and the like; the first processor 101 configures the first digital audio circuit 102 according to the first configuration parameter, and the second processor 303 configures the second digital audio circuit 304 according to the second configuration parameter; and after configuration on the first digital audio circuit 102 and the second digital audio circuit 304 is complete, the interface isolator 103 receives a connection command, and switches from the disconnected state to a connected state according to the connection command, so that a channel among the first digital audio circuit 102, the first digital audio connecting apparatus 106, the second digital audio connecting apparatus 307, and the second digital audio circuit 304 is connected, and voice data transmission may be performed between the first processor 101 and the second processor 303 by using the first digital audio circuit 102, the first digital audio connecting apparatus 106, the second digital audio connecting apparatus 307, and the second digital audio circuit 304.

Optionally, in this embodiment of the present invention, the first connecting apparatus 105 is connected to the second connecting apparatus 306 in a swappable manner; and the interface isolator 103 switches from the connected state to the disconnected state after a connection between the first connecting apparatus 105 and the second connecting apparatus 306 is disconnected.

Optionally, in this embodiment of the present invention, the first digital audio connecting apparatus 106 and the first USB connecting apparatus 107 are integrated in the first connecting apparatus 105, and the second digital audio connecting apparatus 307 and the second USB connecting apparatus 308 are integrated in the second connecting apparatus 306.

Optionally, in this embodiment of the present invention, that the interface isolator 103 receives a connection command is specifically that: the interface isolator 103 receives the connection command from the first digital audio circuit 102; or the interface isolator 103 receives the connection command from the first processor 101.

Optionally, in this embodiment of the present invention, the first digital audio circuit 102 may be a PCM circuit or an IIS circuit, and the second digital audio circuit 304 may be a PCM circuit or an IIS circuit.

In this embodiment of the present invention, after the first connecting apparatus 105 of the data terminal 301 is connected to the second connecting apparatus 306 of the computer 302, service data or a system control command sent by the second processor 303 of the computer 302 is transmitted to the first processor 101 by using the second USB circuit 305, the second connecting apparatus 306, the first USB connecting apparatus 107, and the first USB circuit 104, so that the first processor 101 may obtain the service data or the system control command sent by the second processor 303 of the computer 302; or the first processor 101 may send service data or a system control command to the second processor 303 by using the first USB circuit 104, the first USB connecting apparatus 107, the second USB connecting apparatus 308, and the second USB circuit 305, so that the second processor 303 of the computer 302 may receive the service data or the system control command sent by the first processor 101 of the data terminal 301.

In this embodiment of the present invention, after the interface isolator 103 switches from the disconnected state to the connected state, voice data transmission may be further implemented between the computer 302 and the data terminal 301. Specifically, voice data sent by the second processor 303 of the computer 302 is transmitted to the first processor 101 by using the second digital audio connecting apparatus 307, the second digital audio circuit 304, the first digital audio connecting apparatus 106, and the first digital audio circuit 102, so that the first processor 101 may obtain the voice data sent by the second processor 303 of the computer 302, or the first processor 101 of the data terminal 301 may send voice data to the second processor 303 of the computer 302 by using the first digital audio circuit 102, the first digital audio connecting apparatus 106, the second digital audio connecting apparatus 307, and the second digital audio circuit 304, so that the second processor 303 of the computer 302 may receive the voice data sent by the first processor 101 of the data terminal 301.

In this embodiment of the present invention, when the interface isolator 103 is in the connected state, if a connection between the data terminal 301 and the computer 302 is disconnected or the computer 302 is powered off, the interface isolator 103 switches from the connected state to the disconnected state.

In this embodiment of the present invention, the disconnected state of the interface isolator 103 refers to that a pin of the interface isolator 103 is in a high-impedance state; or when a pin on a side on which the interface isolator 103 is connected to the computer 32 is in an input state, and the pin does not affect a change of a level of a connected signal cable, a state in which the interface isolator 103 is also the disconnected state. The connected state of the interface isolator 103 refers to another state, except for the disconnected state, in which data transmission can be performed normally.

It should be noted that, in this embodiment of the present invention, there may be a plurality of implementation manners of disconnecting and connecting a channel between the first digital audio circuit 102 and the first digital audio connecting apparatus 106, using the interface isolator 103 is only one feasible implementation manner of the plurality of implementation manners, and another hardware manner such as a switch may be used for implementation, or a software manner may also be used for implementation, provided that connection and disconnection of the channel between the first digital audio circuit 102 and the first digital audio connecting apparatus 106 can be implemented. Therefore, in an actual application, an implementation manner of the connection and the disconnection of the channel may be set according to a specific situation.

In the data transmission system in this embodiment of the present invention, a data terminal 301 includes a first digital audio circuit 102 configured to transmit voice data and an interface isolator 103 configured to implement hot swapping control over the first digital audio circuit 102; after a first connecting apparatus 105 of the data terminal 301 is connected to a second connecting apparatus 306 of a computer 302, an initial status of the interface isolator 103 is a disconnected state and a first USB circuit 104 and a second USB circuit 305 enter an initialization process; after initialization is complete, a first processor 101 of the data terminal 301 may negotiate with a second processor 303 of the computer 302 by using the first USB circuit 104, a first USB connecting apparatus 107, a second USB connecting apparatus 308, and the second USB circuit 305, and determine a first configuration parameter of the first digital audio circuit 102 and a second configuration parameter of a second digital audio circuit 304; the first processor 101 configures the first digital audio circuit 102 according to the first configuration parameter, and the second processor 303 configures the second digital audio circuit 304 according to the second configuration parameter; after the configuration on the first digital audio circuit 102 and the second digital audio circuit 304 is complete, the interface isolator 103 receives a connection command, and the interface isolator 103 switches from the disconnected state to a connected state according to the connection command, so that a channel among the first digital audio circuit 102, a first digital audio connecting apparatus 106, a second digital audio connecting apparatus 307, and the second digital audio circuit 304 is connected, implementing the hot swapping control over the first digital audio circuit 102. Therefore, the first digital audio circuit 102 may be used in the data terminal 301 to implement voice data transmission.

The first connecting apparatus 105, the second connecting apparatus 306, the first digital audio connecting apparatus 106, the first USB connecting apparatus 107, the second digital audio connecting apparatus 307, and the second USB connecting apparatus 308, and the like that are mentioned in this embodiment of the present invention may be a connecting groove, a connector, a socket, or the like, where a circuit pin may be included.

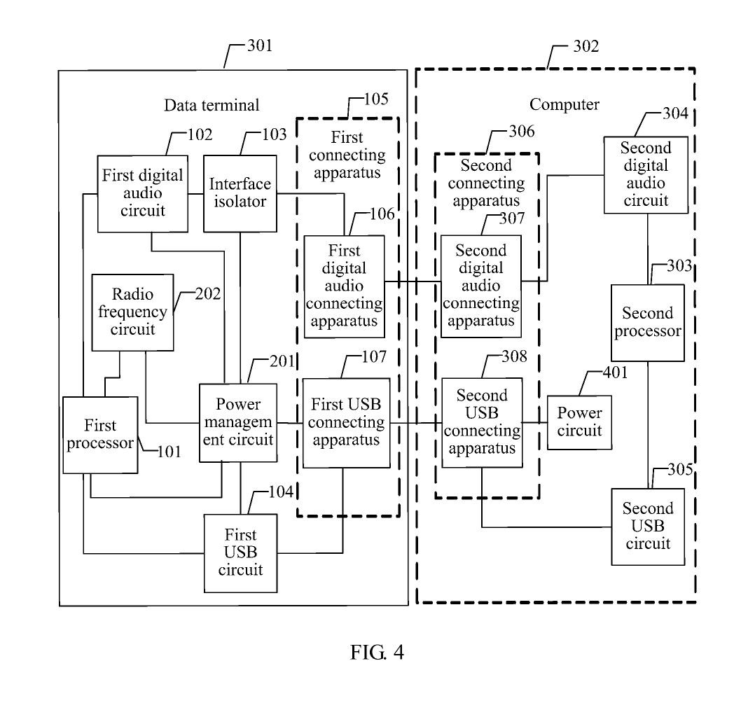

Referring to FIG. 4, FIG. 4 is a schematic diagram of a data transmission system according to an embodiment of the present invention, where the data transmission system includes: the data terminal 301 and the computer 302 that are described in the embodiment shown in FIG. 3. Content of the data terminal 301 and the computer 302 is similar to the content described in the embodiment shown in FIG. 3, and details are not described herein again.

In this embodiment of the present invention, the data terminal 301 may further include a power management circuit 201, and the computer 302 may further include a power circuit 401; the power management circuit 201 is connected to the first processor 101, the first digital audio circuit 102, the interface isolator 103, and the first USB circuit 104; and the power circuit 401 is connected to the second USB connecting apparatus 308.

The power management circuit 201 is further connected to the first connecting apparatus 105, so that after the first connecting apparatus 105 is connected to the second connecting apparatus 306, the power management circuit 201 is configured to acquire electric energy from the power circuit 401, and provide electric energy for the first processor 101, the first digital audio circuit 102, the interface isolator 103, and the first USB circuit 104.

In this embodiment of the present invention, the data terminal 301 may further include a radio frequency circuit 202 that is configured to send a radio frequency signal to a wireless network or receive a radio frequency signal from a wireless network, the radio frequency circuit 202 is connected to the first processor 101 and the power management circuit 201, and the power management circuit 201 provides electric energy for the radio frequency circuit 202.

In this embodiment of the present invention, the first processor 101 is further configured to: after the interface isolator 103 switches from a disconnected state to a connected state, receive voice data that is transmitted by the second processor 303 by using the second digital audio circuit 304, the second digital audio connecting apparatus 307, the first digital audio connecting apparatus 106, and the first digital audio circuit 102, process the voice data to obtain a baseband signal, and send the baseband signal to the radio frequency circuit 202; and the radio frequency circuit 202 is configured to modulate the baseband signal into a radio frequency signal, and send the radio frequency signal to the wireless network.

In this embodiment of the present invention, the first processor 101 is further configured to: receive service data that is sent by the second processor 303 by using the second USB connecting apparatus 308, the second USB circuit 305, the first USB connecting apparatus 107, and the first USB circuit 104, process the service data to obtain a baseband signal, and send the baseband signal to the radio frequency circuit 202; and the radio frequency circuit 202 is configured to modulate the baseband signal into a radio frequency signal and send the radio frequency signal to the wireless network.

In this embodiment of the present invention, the radio frequency circuit 202 is further configured to: receive a radio frequency signal sent by the wireless network, modulate the radio frequency signal into a baseband signal, and send the baseband signal to the first processor 101; and the first processor 101 is further configured to: process the baseband signal to obtain voice data or service data, send the voice data to the second processor 303 by using the first digital audio circuit 102, the first digital audio connecting apparatus 106, the second digital audio connecting apparatus 307, and the second digital audio circuit 304, or send the service data to the second processor 303 by using the first USB circuit 104, the first USB connecting apparatus 107, the second USB connecting apparatus 308, and the second USB circuit 305.

In this embodiment of the present invention, the first processor 101 is further configured to receive a system control command that is sent by the second processor 303 by using the second USB connecting apparatus 308, the second USB circuit 305, the first USB connecting apparatus 107, and the first USB circuit 104.

In this embodiment of the present invention, the first processor 101 is further configured to send a system control command to the second processor 303 by using the first USB circuit 104, the first USB connecting apparatus 107, the second USB connecting apparatus 308, and the second USB circuit 305.

In this embodiment of the present invention, voice data transmission may be performed between the second processor 303 of the computer 302 and the first processor 101 of the data terminal 301. Voice data sent by the second processor 303 of the computer 302 to the first processor 101 may be data obtained by means of collection by a voice device, such as a microphone, of the computer 302. After collecting the data, the second processor 303 performs processing, such as echo elimination, environmental noise elimination, recording, or voice reorganization on the data, and transmits voice data obtained after the processing to the first processor 101 by using the second digital audio circuit 304, the second digital audio connecting apparatus 307, the first digital audio connecting apparatus 106, and the first digital audio circuit 102. After receiving the voice data, the first processor 101 performs processing such as encryption, encoding, framing, encapsulation, and conversion, on the voice data to obtain a baseband signal, and sends the baseband signal to the radio frequency circuit 202; the radio frequency circuit 202 modulates the baseband signal into a radio frequency signal, and sends the radio frequency signal to a wireless network. If the radio frequency circuit 202 receives a radio frequency signal that includes voice data, the radio frequency circuit 202 modulates the radio frequency signal into a baseband signal, and sends the baseband signal to the first processor 101; the first processor 101 processes the baseband signal to obtain the voice data, and the first processor 101 transmits the voice data to the second processor 303 by using the first digital audio circuit 102, the first digital audio connecting apparatus 106, the second digital audio connecting apparatus 307, and the second digital audio circuit 304. The second processor 303 may process the voice data, and broadcast, by using a voice device of the computer 302, voice data after the processing, so that a user can hear voice.

In the data transmission system in this embodiment of the present invention, a data terminal 301 includes a first digital audio circuit 102 configured to transmit voice data and an interface isolator 103 configured to implement hot swapping control over the first digital audio circuit 102, so that after a first connecting apparatus 105 of the data terminal 301 is connected to a second connecting apparatus 306 of a computer 302, an initial status of the interface isolator 103 is a disconnected state and a first USB circuit 104 and a second USB circuit 305 enter an initialization process; after initialization is complete, a first processor 101 of the data terminal 301 may negotiate with a second processor 303 of the computer 302 by using the first USB circuit 104, a first USB connecting apparatus 107, a second USB connecting apparatus 308, and the second USB circuit 305, and determine a configuration parameter of the first digital audio circuit 102 and a configuration parameter of a second digital audio circuit 304; the first processor 101 and he second processor 303 respectively complete parameter configuration on the first digital audio circuit 102 and the second digital audio circuit 304 according to the corresponding configuration parameters; after the configuration is complete, the interface isolator 103 receives a connection command, and the interface isolator 103 switches from the disconnected state to a connected state according to the connection command, so that a channel among the first digital audio circuit 102, a first digital audio connecting apparatus 106, a second digital audio connecting apparatus 307, and the second digital audio circuit 304 is connected, implementing the hot swapping control over the first digital audio circuit 102. Therefore, the first digital audio circuit 102 may be used in the data terminal 301 to implement voice data transmission.

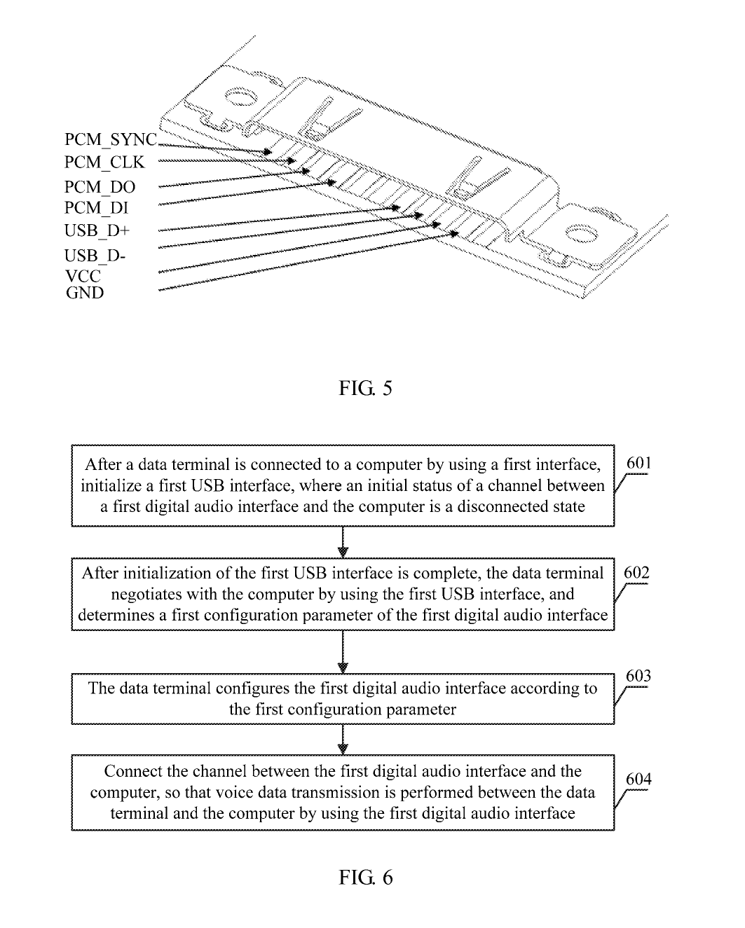

For a better understanding of the first connecting apparatus in this embodiment of the present invention, in an example in which the first digital audio circuit 102 is PCM circuit, a structural diagram of an entity of the first connecting apparatus is described, and reference is made to FIG. 5. Pins of the first connecting apparatus includes: PCM_SYNC, PCM_CLK, PCM_DO, PCM_DI, USB_D+, USB_D−, VCC, and GND, where the pins PCM_SYNC, PCM_CLK, PCM_DO, and PCM_DI are pins connected to the first digital audio circuit 102, the pins USB_D+ and USB_D− are pins connected to the first USB circuit 104, and the pins VCC and GND are pins connected to the power management circuit 201.

Referring to FIG. 6, FIG. 6 is a schematic diagram of a hot swapping control method of a data terminal according to an embodiment of the present invention. In this embodiment of the present invention, the data terminal includes a first interface, where the first interface includes a first digital audio interface and a first USB interface, and the first USB interface has a hot swapping feature. The hot swapping control method of the data terminal includes:

601. After the data terminal is connected to a computer by using the first interface, initialize the first USB interface, where an initial status of a channel between the first digital audio interface and the computer is a disconnected state.

In this embodiment of the present invention, after the data terminal is connected to the computer by using the first interface, the first USB interface is initialized, where the initial status of the channel between the first digital audio interface and the computer is the disconnected state.

In this embodiment of the present invention, the data terminal may be the data terminal described in any of the embodiments shown in FIG. 1 to FIG. 4; the first digital audio interface includes the first digital audio connecting apparatus 106, the interface isolator 103, and the first digital audio circuit 102; the first USB interface includes the first USB circuit 104 and the first USB connecting apparatus 107.

In this embodiment of the present invention, after the data terminal is connected to the computer by using the first interface, because an initial status of the interface isolator 103 is a disconnected state, the initial status of the channel between the first digital audio interface and the computer is the disconnected state.

602. After initialization of the first USB interface is complete, the data terminal negotiates with the computer by using the first USB interface, and determines a first configuration parameter of the first digital audio interface.

In this embodiment of the present invention, after the initialization of the first USB interface is complete, the data terminal negotiates with the computer by using the first USB interface, and determines the first configuration parameter of the first digital audio interface.

603. The data terminal configures the first digital audio interface according to the first configuration parameter.

In this embodiment of the present invention, the data terminal configures the first digital audio interface according to the first configuration parameter.

604. Connect the channel between the first digital audio interface and the computer, so that voice data transmission is performed between the data terminal and the computer by using the first digital audio interface.

In this embodiment of the present invention, after the data terminal completes configuration on the first digital audio interface, the channel between the first digital audio interface and the computer is connected, so that the voice data transmission is performed between the data terminal and the computer by using the first digital audio interface.

In this embodiment of the present invention, after the data terminal connects the channel between the first digital audio interface and the computer, the data terminal may receive, by using the first digital audio interface, voice data transmitted by the computer, or receive, by using the first USB interface, service data transmitted by the computer; in addition, the data terminal further processes the voice data or the service data to obtain a radio frequency signal, and sends the radio frequency signal to a wireless network.

In this embodiment of the present invention, after the data terminal connects the channel between the first digital audio interface and the computer, the data terminal may further receive a radio frequency signal sent by a wireless network, and process the radio frequency signal to obtain voice data or service data; and if what is obtained by means of processing is voice data, the data terminal transmits the voice data to the computer by using the first digital audio interface, or if what is obtained by means of processing is service data, the data terminal transmits the service data to the computer by using the first USB interface.

In this embodiment of the present invention, after the data terminal is connected to the computer by using the first interface, the data terminal may further receive, by using the first USB interface, a system control command sent by the computer, or send a system control command to the computer by using the first USB interface. For example, the system control command may be a configuration parameter negotiation command.

In this embodiment of the present invention, after a data terminal is connected to a computer by using a first interface, a first USB interface of the first interface is initialized, and an initial status of a channel between a first digital audio interface of the first interface and the computer is a disconnected state; after the initialization of the first USB interface is complete, the data terminal negotiates with the computer by using the first USB interface, determines a first configuration parameter of the first digital audio interface, and configures the first digital audio interface according to the first configuration parameter; after the configuration is complete, the channel between the first digital audio interface and the computer is connected, implementing hot swapping control over the first digital audio interface. Therefore, the first digital audio interface may be used in the data terminal to implement voice data transmission.

A person of ordinary skill in the art may understand that all or a part of the steps of the methods in the foregoing embodiment may be implemented by a program instructing relevant hardware. The program may be stored in a computer readable storage medium. By running the program in the readable storage medium, the hot swapping control method in the foregoing embodiment is implemented. The foregoing mentioned storage medium may be a read-only memory, a magnetic disk, or an optical disc.

The foregoing provides detailed descriptions of the data terminal, the data transmission system, and the hot swapping control method provided by the present invention. A person of ordinary skill in the art may, based on the idea of the present invention, make modifications with respect to the specific implementation manners and the application scope. Therefore, the content of this specification shall not be construed as a limitation to the present invention.

What is claimed is:

1. A data terminal, comprising:
a first processor, a first digital audio circuit, an interface isolator, a first universal serial bus USB circuit, and a first connecting apparatus, wherein the first connecting apparatus comprises a first digital audio connecting apparatus and a first USB connecting apparatus, and the first USB circuit has a hot swapping feature;
the first processor is connected to the first digital audio circuit, the first processor is further connected to the first USB circuit, the first digital audio circuit is connected to the interface isolator, the interface isolator is connected to the first digital audio connecting apparatus, and the first USB circuit is connected to the first USB connecting apparatus;
after the data terminal is connected to a computer by using the first connecting apparatus, an initial status of the interface isolator is a disconnected state and the first USB circuit enters an initialization process; the first processor is configured to: after initialization of the first USB circuit is complete, negotiate with the computer by using the first USB circuit and the first USB connecting apparatus, determine a first configuration parameter of the first digital audio circuit, and configure the first digital audio circuit according to the first configuration parameter; and
after configuration on the first digital audio circuit is complete, the interface isolator receives a connection command, and switches from the disconnected state to a connected state according to the connection command, so that a channel between the first digital audio circuit and the first digital audio connecting apparatus is connected, and voice data transmission is performed between the first processor and the computer by using the first digital audio circuit and the first digital audio connecting apparatus.

2. The data terminal according to claim 1, wherein the first digital audio connecting apparatus and the first USB connecting apparatus are integrated in the first connecting apparatus.

3. The data terminal according to claim 1, wherein that the interface isolator receives a connection command is specifically that: the interface isolator receives the connection command from the first digital audio circuit; or the interface isolator receives the connection command from the first processor.

4. The data terminal according to claim 1, wherein the first digital audio circuit is a pulse code modulation PCM circuit or an integrate interface of sound IIS circuit.

5. The data terminal according to claim 1, wherein the data terminal further comprises a power management circuit, and the power management circuit is connected to the first processor, the first digital audio circuit, the first USB circuit, and the interface isolator; the power management circuit is configured to provide electric energy for the first processor, the first digital audio circuit, the first USB circuit, and the interface isolator; and the power management circuit is further connected to the first USB connecting apparatus of the first connecting apparatus, so that the power management circuit acquires electric energy from the computer after the first connecting apparatus is connected to the computer.

6. The data terminal according to claim 1, wherein the data terminal further comprises a radio frequency circuit that is configured to send a radio frequency signal to a wireless network or receive a radio frequency signal from a wireless network, the radio frequency circuit is connected to the first processor, and the radio frequency circuit is further connected to the power management circuit.

7. The data terminal according to claim 1, wherein the first processor is further configured to: after the interface isolator switches from the disconnected state to the connected state, receive, by using the first digital audio connecting apparatus and the first digital audio circuit, voice data transmitted by the computer, process the voice data to obtain a baseband signal, and send the baseband signal to the radio frequency circuit, and the radio frequency circuit is configured to modulate the baseband signal into a radio frequency signal, and send the radio frequency signal to the wireless network; the first processor is further configured to: receive, by using the first USB connecting apparatus and the first USB circuit, service data sent by the computer, process the service data to obtain a baseband signal, and send the baseband signal to the radio frequency circuit, and the radio frequency circuit is further configured to modulate the baseband signal into a radio frequency signal, and send the radio frequency signal to the wireless network;
the radio frequency circuit is further configured to: receive a radio frequency signal sent by the wireless network, modulate the radio frequency signal into a baseband signal, and send the baseband signal to the first processor; and the first processor is further configured to: process the baseband signal to obtain voice data or service data, send the voice data to the computer by using the first digital audio circuit and the first digital audio connecting apparatus, or send the service data to the computer by using the first USB circuit and the first USB connecting apparatus; and
the first processor is further configured to receive, by using the first USB connecting apparatus and the first USB circuit, a system control command sent by the computer, or is configured to send a system control command to the computer by using the first USB connecting apparatus and the first USB circuit.

8. The data terminal according to claim 1, wherein the interface isolator switches from the connected state to the disconnected state after the data terminal is disconnected from the computer.

9. A data transmission system, comprising: a data terminal and a computer, wherein
the data terminal comprises a first processor, a first digital audio circuit, an interface isolator, a first universal serial bus USB circuit, and a first connecting apparatus, wherein the first connecting apparatus comprises a first digital audio connecting apparatus and a first USB connecting apparatus, and the first USB circuit has a hot swapping feature;
the first processor is connected to the first digital audio circuit, the first processor is further connected to the first USB circuit, the first digital audio circuit is connected to the interface isolator, the interface isolator is connected to the first digital audio connecting apparatus, and the first USB circuit is connected to the first USB connecting apparatus;
the computer comprises a second processor, a second digital audio circuit, a second USB circuit, a second connecting apparatus, wherein the second connecting apparatus comprises a second digital audio connecting apparatus and a second USB connecting apparatus, and the second USB circuit has a hot swapping feature;
the second processor is connected to the second digital audio circuit, the second processor is further connected to the second USB circuit, the second digital audio circuit is connected to the second digital audio connecting apparatus, and the second USB circuit is connected to the second USB connecting apparatus;
the first connecting apparatus is configured to connect to the second connecting apparatus, so that the data terminal is connected to the computer, wherein the first digital audio connecting apparatus is configured to connect to the second digital audio connecting apparatus, and the first USB connecting apparatus is configured to connect to the second USB connecting apparatus;
after the data terminal is connected to the second connecting apparatus of the computer by using the first connecting apparatus, an initial status of the interface isolator is a disconnected state, and the first USB circuit and the second USB circuit enter an initialization process; after initialization of the first USB circuit and the second USB circuit is complete, the first processor negotiates with the second processor by using the first USB circuit, the first USB connecting apparatus, the second USB connecting apparatus, and the second USB circuit, and determines a first configuration parameter of the first digital audio circuit and a second configuration parameter of the second digital audio circuit; the first processor configures the first digital audio circuit according to the first configuration parameter, and the second processor configures the second digital audio circuit according to the second configuration parameter; and
after configuration on the first digital audio circuit and the second digital audio circuit is complete, the interface isolator receives a connection command, and switches from the disconnected state to a connected state according to the connection command, so that a channel among the first digital audio circuit, the first digital audio connecting apparatus, the second digital audio connecting apparatus, and the second digital audio circuit is connected, and voice data transmission is performed between the first processor and the second processor by using the first digital audio circuit, the first digital audio connecting apparatus, the second digital audio connecting apparatus, and the second digital audio circuit.

10. The data transmission system according to claim 9, wherein the first connecting apparatus is connected to the second connecting apparatus in a swappable manner; and
the interface isolator switches from the connected state to the disconnected state after a connection between the first connecting apparatus and the second connecting apparatus is disconnected.

11. The data transmission system according to claim 9, wherein the first digital audio connecting apparatus and the first USB connecting apparatus are integrated in the first connecting apparatus; and
the second digital audio connecting apparatus and the second USB connecting apparatus are integrated in the second connecting apparatus.

12. The data transmission system according to claim 9, wherein that the interface isolator receives a connection command is specifically that: the interface isolator receives the connection command from the first digital audio circuit; or the interface isolator receives the connection command from the first processor.

13. The data transmission system according to claim 9, wherein the first digital audio circuit is a pulse code modulation PCM circuit or an integrate interface of sound IIS circuit, and the second digital audio circuit is a PCM circuit or an IIS circuit.

14. The data transmission system according to claim 9, wherein the data terminal further comprises a power management circuit, and the computer further comprises a power circuit;
the power management circuit is connected to the first processor, the first digital audio circuit, the interface isolator, and the first USB circuit; and
the power management circuit is further connected to the first USB connecting apparatus, and the power circuit is connected to the second USB connecting apparatus, so that after the first USB connecting apparatus and the second connecting apparatus are connected, the power management circuit is configured to acquire electric energy from the power circuit and provide electric energy for the first processor, the first digital audio circuit, the interface isolator, and the first USB circuit.

15. The data transmission system according to claim 9, wherein the data terminal further comprises a radio frequency circuit that is configured to send a radio frequency signal to a wireless network or receive a radio frequency signal from a wireless network, the radio frequency circuit is connected to the first processor, and the radio frequency circuit is connected to the power management circuit.

16. The data transmission system according to claim 9, wherein
the first processor is further configured to: after the interface isolator switches from the disconnected state to the connected state, receive voice data that is transmitted by the second processor by using the second digital audio circuit, the second digital audio connecting apparatus, the first digital audio connecting apparatus, and the first digital audio circuit, process the voice data to obtain a baseband signal, and send the baseband signal to the radio frequency circuit, and the radio frequency circuit is configured to modulate the baseband signal into a radio frequency signal, and send the radio frequency signal to the wireless network; and the first processor is further configured to: receive service data that is sent by the second processor by using the second USB connecting apparatus, the second USB circuit, the first USB connecting apparatus, and the first USB circuit, process the service data to obtain a baseband signal, and send the baseband signal to the radio frequency circuit, and the radio frequency circuit is further configured to modulate the baseband signal into a radio frequency signal, and send the radio frequency signal to the wireless network;
the radio frequency circuit is further configured to: receive a radio frequency signal sent by the wireless network, modulate the radio frequency signal into a baseband signal, and send the baseband signal to the first processor; and the first processor is further configured to: process the baseband signal to obtain voice data or service data, send the voice data to the second processor by using the first digital audio circuit, the first digital audio connecting apparatus, the second digital audio connecting apparatus, and the second digital audio circuit, or send the service data to the second processor by using the first USB circuit, the first USB connecting apparatus, the second USB connecting apparatus, and the second USB circuit; and
the first processor is further configured to receive a system control command that is sent by the second processor by using the second USB connecting apparatus, the second USB circuit, the first USB connecting apparatus, and the first USB circuit, or is configured to send a system control command to the second processor by using the first USB circuit, the first USB connecting apparatus, the second USB connecting apparatus, and the second USB circuit.

17. A hot swapping control method, wherein the hot swapping control method is applied to a data terminal, and the data terminal comprises a first interface, wherein the first interface comprises a first digital audio interface and a first USB interface, and the first USB interface has a hot swapping feature; and
the hot swapping control method comprises:
after the data terminal is connected to a computer by using the first interface, initializing the first USB interface, wherein an initial status of a channel between the first digital audio interface and the computer is a disconnected state;
after initialization of the first USB interface is complete, negotiating, by the data terminal, with the computer by using the first USB interface, and determining a first configuration parameter of the first digital audio interface;
configuring, by the data terminal, the first digital audio interface according to the first configuration parameter; and
connecting the channel between the first digital audio interface and the computer, so that voice data transmission is performed between the data terminal and the computer by using the first digital audio interface.

18. The method according to claim 17, after the connecting the channel between the first digital audio interface and the computer, further comprising:
receiving, by the data terminal by using the first digital audio interface, voice data transmitted by the computer, or receiving, by using the first USB interface, service data transmitted by the computer; and
processing, by the data terminal, the voice data or the service data to obtain a radio frequency signal, and sending the radio frequency signal to a wireless network.

19. The method according to claim 17, after the connecting the channel between the first digital audio interface and the computer, further comprising:
receiving, by the data terminal, a radio frequency signal sent by the wireless network;
processing, by the data terminal, the radio frequency signal to obtain voice data or service data; and
transmitting, by the data terminal, the voice data to the computer by using the first digital audio interface, or transmitting the service data to the computer by using the first USB interface.

20. The method according to claim 17, wherein the method further comprises:
receiving or sending, by the data terminal, a system control command by using the first USB interface.
